(19) United States
(12) Patent Application Publication
(10) Pub. No.: US 2015/0365363 A1
(43) Pub. Date: Dec. 17, 2015

(54) METHOD AND SYSTEM FOR EXCHANGING INSTANT MESSAGES BETWEEN ONE OR MORE USERS USING MEDIA AS REFERENCE

(71) Applicant: Satellite Technologies, LLC, Minneapolis, MN (US)

(72) Inventors: Amit Ramchandran, Foster City, CA (US); Kshitij, Cupertino, CA (US)

(21) Appl. No.: 14/741,356

(22) Filed: Jun. 16, 2015

Related U.S. Application Data
(60) Provisional application No. 62/013,418, filed on Jun. 17, 2014.

(51) Int. Cl. H04L 12/58

(52) U.S. Cl. CPC H04L 51/046; H04L 51/08

(57) ABSTRACT

A system, method and computer program product for transmitting online content to one or more recipients through online messaging, including a selectable button embedded within online content; and an online messaging mechanism. The selectable button is configured upon selection to transmit the online content as a generated message to one or more recipients through the online messaging mechanism.

### CROSS REFERENCE TO RELATED APPLICATIONS

The present invention claims priority to U.S. Provisional Patent Application Ser. No. 62/013,418 of Kshitij et al., entitled “METHOD AND SYSTEM FOR EXCHANGING INSTANT MESSAGES BETWEEN ONE OR MORE USERS USING MEDIA AS REFERENCE,” filed on Jun. 17, 2014, the entire disclosure of which is hereby incorporated by reference herein.

### BACKGROUND OF THE INVENTION

1. Field of the Invention

The present invention generally relates to systems and methods for online messaging, and the like, more particularly to systems and methods for exchanging instant messages between one or more users using media as reference, and the like.

2. Discussion of the Background

In recent years, systems and methods have been developed to allow users to exchange messages using a wide variety of messaging services. Users often include their own photos and videos, content from other applications, Internet content, and the like, as part of the message to serve as a reference. However, the process of bringing content into a message involves multiple steps, especially when content from other applications or Internet content is used as a reference. For example, typical messaging systems and methods require users to either copy-and-paste or navigate through menus with a wide range of choices. Typical messaging systems also involve more than one application in order to import content.

### SUMMARY OF THE INVENTION

Therefore, there is a need for methods and systems that address the above and other problems with conventional systems and methods for messaging, and the like. Accordingly, the above and other needs are addressed by the illustrative embodiments of the present invention, which provide a novel method and system that attach messages to content as opposed to bringing content into messages to make it both easy and seamless to communicate using references in the digital world just like users do today in the real world. Advantageously, the method and system allow users to use content in their messages by touching or selecting just once on a message button, and the like, for example, placed on the content instead of selecting or copying and pasting content into a message. Messaging on content automatically attaches it as a reference in a conversation. Using this invention, users can string together a conversation using a wide variety of content as reference.

Accordingly, in an illustrative aspect, there is provided a system, method and computer program product for transmitting online content to one or more recipients through online messaging, including a selectable button embedded within online content; and an online messaging mechanism. The selectable button is configured upon selection to transmit the online content as a generated message to one or more recipients through the online messaging mechanism.

The online messaging mechanism includes an instant messaging mechanism, and the selectable content is displayed on a device, including mobile phone, tablet, laptop or PC.

The online content in the transmitted messages is shown within a single application, or the online content from more than one application is represented within a single application.

Provided are action buttons configured to allow a user to take predetermined actions, including buying a product or service, or scheduling an appointment directly from the transmitted messages based on the online content.

The online content is from a web page, and the generated message is related to conversations via a web browser.

The online content includes locations on a map of a map application, and the generated message is related to in conversations sent directly from the map application.

Still other aspects, features, and advantages of the present invention are readily apparent from the following detailed description, simply by illustrating a number of illustrative embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings, in which like reference numerals refer to similar elements, and in which:

FIG. 1 illustrates a single application including a collection of sub-applications from which media can be used in online conversations, and the like;

FIG. 2 illustrates a third party application from which media can be used in online conversations, and the like;

FIG. 3 An internet browser that displays web pages which in turn can be used in online conversations, and the like;

FIG. 4 illustrates a map, locations of which online conversations, and the like;

FIG. 5 illustrates a flow chart of processes performed by the inventions of FIGS. 1-4; and

FIG. 6 illustrates a detailed view of content referenced in a chat thread shown in FIG. 5.

### DETAILED DESCRIPTION OF THE PREFERRED EMBODIMENTS

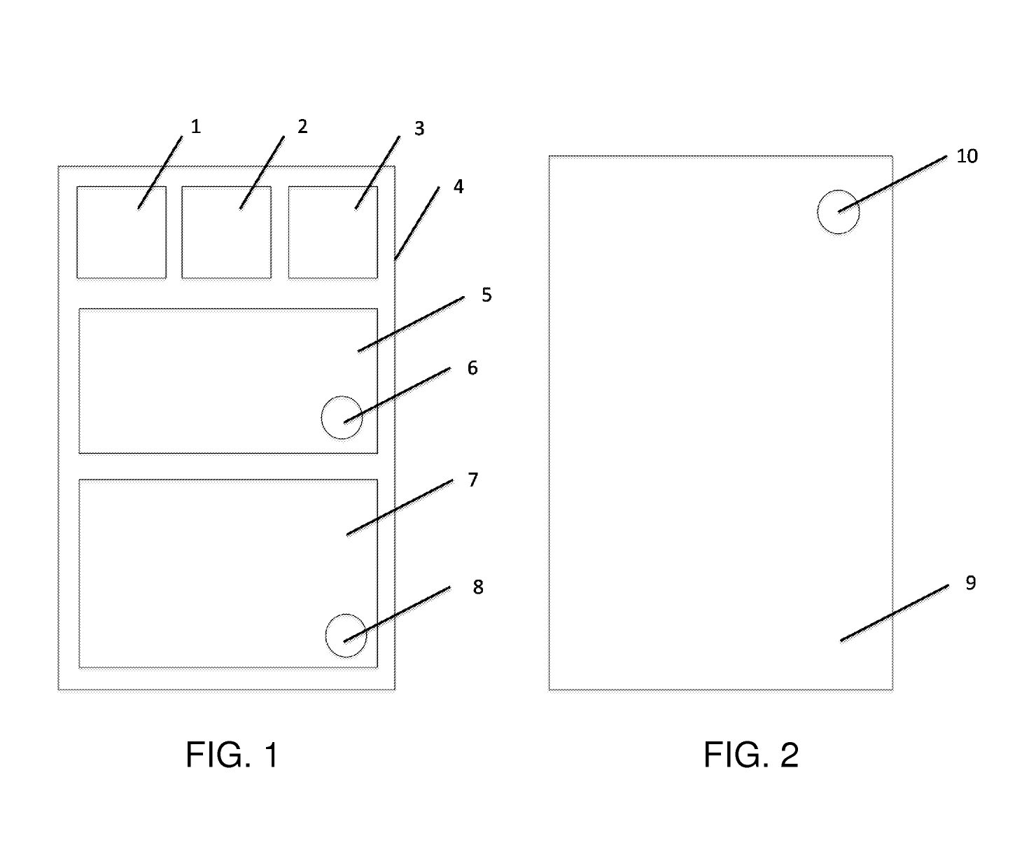

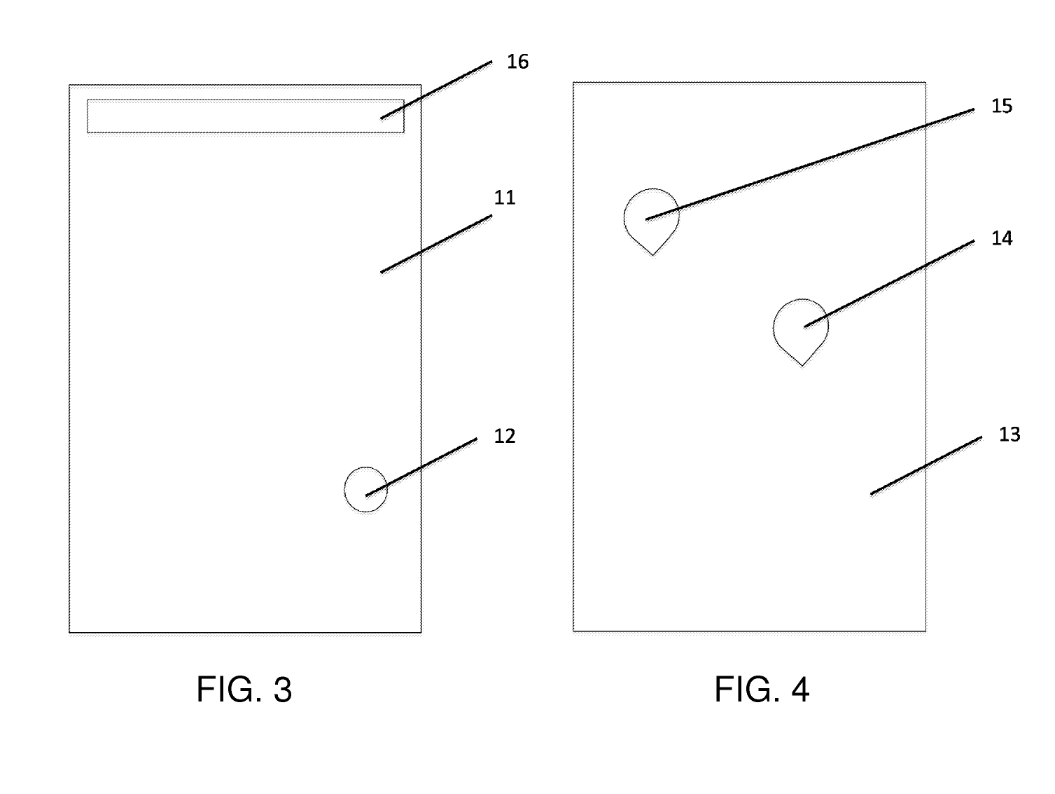

Referring now to the invention in more detail, FIG. 1 shows an application 4 displaying sources of content 1, 2 and 3, wherein, for example, the source 2 is selected. Elements 5 and 7, for example, are two different pieces of content in the source 2. In FIG. 2, element 9 is, for example, a third party application displaying content on a display screen, browser screen, and the like, of a phone, tablet, PC, and the like. For example, FIG. 3 shows web page content 11 displayed in a browser corresponding to a Uniform Resource Locator (URL) bar or data field 16. Elements 6, 8, 10 and 12 shown in FIGS. 1-3 are messaging icons or buttons, and the like, that invoke a messaging service, and the like. The icons 6, 8, 10 and 12 can be placed in any suitable location, for example, near or on top of the content that is being referenced, and the like.

The sources 1, 2 and 3, for example, can be three different applications, the content of which has been presented within, for example, a third party application 4, and the like. The application 4 can be related to, for example, books, business, catalogues, education, entertainment, finance, food and drink, games, health and fitness, kids, lifestyle, medical, music, navigation, news, photo and video, productivity, reference, social networking, sports, travel, utilities and weather, and the like. Although the three sources 1-3 are shown, numerous sources (n) can be employed, and which can be represented in any suitable form within a given application. When content is included in messages, all of its suitable functions, including play buttons for music, buy buttons for products, and the like, can be included in the generated messages, advantageously, allowing users to take action directly from online conversations, and the like.

The messaging icons 6, 8, 10 and 12 can be placed in any suitable location within a third party application, for example, outside of the main application 4, and the like. The third party application 9, for example, can reside in any suitable location in a phone, tablet, PC, and the like. When the messaging button 10 is touched or selected, and the like, from the third party application 9, the media shown on the corresponding page is automatically attached in the message thread chosen by the user in the application 4. The third party application 9 can be related to, for example, books, business, catalogues, education, entertainment, finance, food and drink, games, health and fitness, kids, lifestyle, medical, music, navigation, news, photo and video, productivity, reference, social networking, sports, travel, utilities and weather, and the like.

FIG. 3 shows a case where the third party application is an Internet browser. The web page content 11 displayed in the browser can be used in conversations by touching the messaging icon 12 on the browser. FIG. 4 shows a case where the third party application is a map 13. In case of a map, the described messaging feature can be invoked by touching on individual locations 14 or 15 on the map 13.

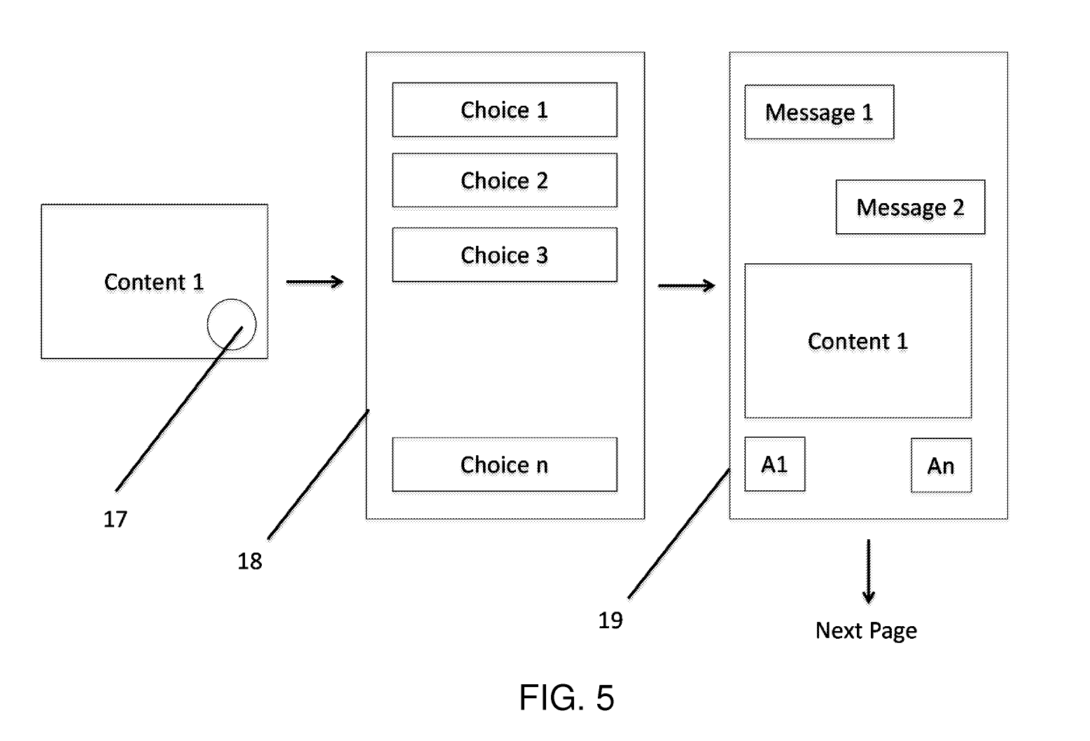

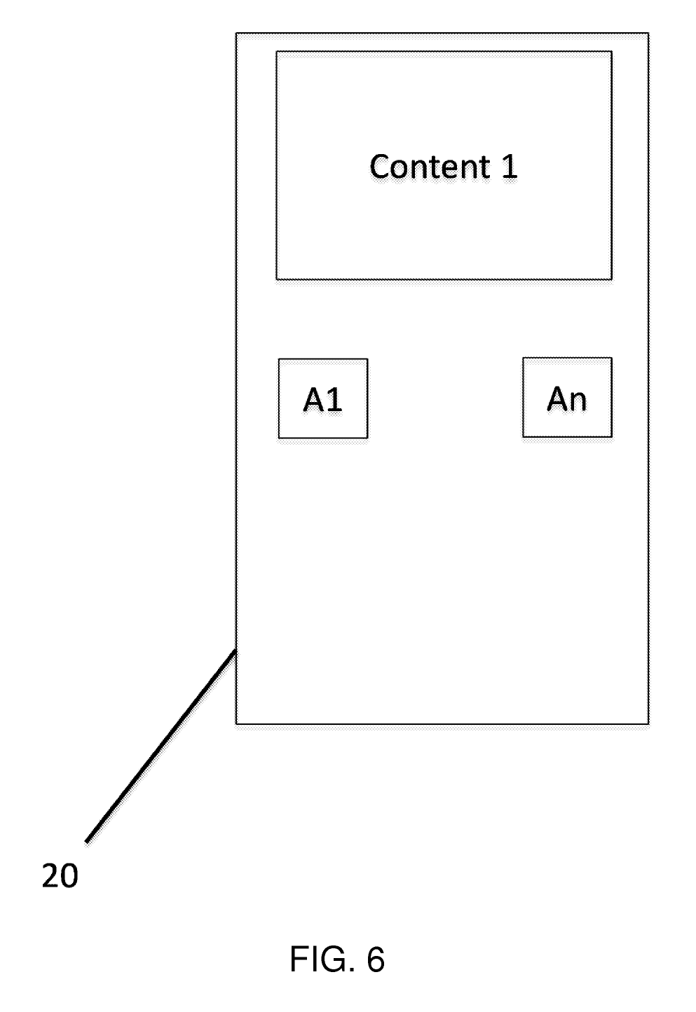

In an illustrative embodiment, for example, a user registers to the service by downloading, installing, and the like, a master application, and then registering the application using, for example, a phone number, email address, Facebook connect, and the like. In a profile page, the user sets a password or a Personal Identification Number (PIN) code to access their account. The master application serves as a central place for receiving messages from other users. For example, by clicking a messaging icon 17 on or near any suitable content 1 in FIG. 5 within the master application 4 or outside thereof, a selection screen 18 opens from which the user is able to choose from one or more choices (1 to n) of contacts or conversations in which they want to use content 1. After making the selection, the content is ready to be sent to an appropriate conversation thread 19. The user can now customize the message with his/her own words, picture, and the like, and send the generated message. If content 1 permits the user to take actions, then the appropriate actions A(1) to A(n) can be shown, displayed, and the like, directly in the chat thread 19. For example, touching or selecting content 1 opens a detailed view, which shows a detailed description along with the actions A(1) to A(n) that the user can take, as shown in FIG. 6.

For example, the user can perform a “send” function, and the like, from a plurality of content with one application from different sources or plurality of content from the same source within one application or different screens in different applications or any suitable web content that employs a messaging application program interface (API), and suitable messaging icon placed near the content. Clicking the messaging icon also generates for the user the option to see the history of all suitable conversations in which the content in view has been referenced, the history thereof, and the like.

The API can also be configured to show messages received from other users, the status of sent messages, and the like. For example, the received messages, and status of sent messages may only be made available in the master application. Advantageously, a user can perform a “send” function, and the like, from a plurality of content within one source or plurality of content across multiple sources, as further described herein.

The above described devices and subsystems of the illustrative embodiments can include, for example, any suitable servers, workstations, PCs, laptop computers, PDAs, Internet appliances, handheld devices, cellular telephones, wireless devices, computer architectures including x86, ARM, MPIS with operating system (OS) platforms including Windows, Linux, iOS, Android, other electronic devices, and the like, capable of performing the processes of the illustrative embodiments. The devices and subsystems of the illustrative embodiments can communicate with each other using any suitable protocol and can be implemented using one or more programmed computer systems or devices. One or more interface mechanisms can be used with the illustrative embodiments, including, for example, Internet access, telecommunications in any suitable form (e.g., voice, modem, and the like), wireless communications media, and the like. For example, employed communications networks or links can include one or more wireless communications networks, cellular communications networks, cable communications networks, satellite communications networks, G3 communications networks, Public Switched Telephone Network (PSTNs), Packet Data Networks (PDNs), the Internet, intranets, WiMAX Networks, “cloud” computer networks, virtual machine and hosting networks, a combination thereof, and the like.

It is to be understood that the devices and subsystems of the illustrative embodiments are for illustrative purposes, as many variations of the specific hardware and/or software used to implement the illustrative embodiments are possible, as will be appreciated by those skilled in the relevant art(s). For example, the functionality of one or more of the devices and subsystems of the illustrative embodiments can be implemented via one or more programmed computer systems or devices.

To implement such variations as well as other variations, a single computer system can be programmed to perform the special purpose functions of one or more of the devices and subsystems of the illustrative embodiments. On the other hand, two or more programmed computer systems or devices can be substituted for any one of the devices and subsystems of the illustrative embodiments. Accordingly, principles and advantages of distributed processing, such as redundancy, replication, and the like, also can be implemented, as desired, to increase the robustness and performance the devices and subsystems of the illustrative embodiments.

The devices and subsystems of the illustrative embodiments can store information relating to various processes described herein. This information can be stored in one or more memories, such as a hard disk, optical disk, magneto-optical disk, RAM, and the like, of the devices and subsystems of the illustrative embodiments. One or more databases of the devices and subsystems of the illustrative embodiments can store the information used to implement the illustrative embodiments of the present invention. The databases can be organized using data structures (e.g., records, tables, arrays, fields, graphs, trees, lists, and the like) included in one or more memories or storage devices listed herein. The processes described with respect to the illustrative embodiments can include appropriate data structures for storing data collected and/or generated by the processes of the devices and subsystems of the illustrative embodiments in one or more databases thereof. All or a portion of the devices and subsystems of the illustrative embodiments can be conveniently implemented using one or more general purpose computer systems, microprocessors, digital signal processors, micro-controllers, application processors, domain specific processors, application specific signal processors, and the like, programmed according to the teachings of the illustrative embodiments of the present invention, as will be appreciated by those skilled in the computer and software arts. Appropriate software can be readily prepared by programmers of ordinary skill based on the teachings of the illustrative embodiments, as will be appreciated by those skilled in the software art. In addition, the devices and subsystems of the illustrative embodiments can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present invention can include software for controlling the devices and subsystems of the illustrative embodiments, for driving the devices and subsystems of the illustrative embodiments, for enabling the devices and subsystems of the illustrative embodiments to interact with a human user, and the like. Such software can include, but is not limited to, device drivers, firmware, operating systems, development tools, applications software, and the like. Such computer readable media further can include the computer program product of an embodiment of the present invention for performing all or a portion (e.g., if processing is distributed) of the processing performed in implementing the illustrative embodiments. Computer code devices of the illustrative embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, SW frameworks including .NET/CLR, JVM, scripting frameworks including PHP, Python, Perl, Shell, and the like. Moreover, parts of the processing of the illustrative embodiments of the present invention can be distributed for better performance, reliability, cost, and the like.

As stated above, the devices and subsystems of the illustrative embodiments can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, flash memories, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, transmission media including WiFi/802.11, BT, 3G, LTE, and the like. Common forms of computer-readable media can include, for example, a floppy disk, a flexible disk, hard disk, magnetic tape, any other suitable magnetic medium, a CD-ROM, CDRW, DVD, solid-state drive (SSD) storage devices, any other suitable optical medium, punch cards, paper tape, optical mark sheets, any other suitable physical medium with patterns of holes or other optically recognizable indicia, a RAM, a PROM, an EPROM, a FLASH-EPROM, a DRAM, a DDR, a NAND/NOR flash device, any other suitable memory chip or cartridge, a carrier wave, or any other suitable medium from which a computer can read.

While the present invention have been described in connection with a number of illustrative embodiments and implementations, the present invention is not so limited, but rather covers various modifications and equivalent arrangements, which fall within the purview of appended claims.

What is claimed is:

1. A computer implemented system for transmitting online content to one or more recipients through online messaging, the system comprising:
a selectable button embedded within online content; and
an online messaging mechanism;
wherein the selectable button is configured upon selection to transmit the online content as a generated message to one or more recipients through the online messaging mechanism.

2. The system of claim 1, wherein the online messaging mechanism includes an instant messaging mechanism, and the selectable content is displayed on a device, including mobile phone, tablet, laptop or PC.

3. The system of claim 1, wherein the online content in the transmitted messages is shown within a single application, or
wherein the online content from more than one application is represented within a single application.

4. The system of claim 1, further comprising:
action buttons configured to allow a user to take predetermined actions, including buying a product or service, or scheduling an appointment directly from the transmitted messages based on the online content.

5. The system of claim 1, wherein the online content is from a web page, and the generated message is related to conversations via a web browser.

6. The system of claim 1, wherein the online content includes locations on a map of a map application, and the generated message is related to in conversations sent directly from the map application.

7. A computer implemented method for transmitting online content to one or more recipients through online messaging, the method comprising:
embedding a selectable button within online content;
providing an online messaging mechanism; and
transmitting the online content as a generated message to one or more recipients through the online messaging mechanism upon selection of the selectable button.

8. The method of claim 7, wherein the online messaging mechanism includes an instant messaging mechanism, and the selectable content is displayed on a device, including mobile phone, tablet, laptop or PC.

9. The method of claim 7, wherein the online content in the transmitted messages is shown within a single application, or
wherein the online content from more than one application is represented within a single application.

10. The method of claim 7, further comprising:
allowing with action buttons a user to take predetermined actions, including buying a product or service, or scheduling an appointment directly from the transmitted messages based on the online content.

11. The method of claim 7, wherein the online content is from a web page, and the generated message is related to conversations via a web browser.

12. The method of claim 7, wherein the online content includes locations on a map of a map application, and the generated message is related to in conversations sent directly from the map application.

13. A non-transitory computer program product having stored thereon a program that when executed by one or more computer processors cause the one or more computer processors to execute a method for transmitting online content to one or more recipients through online messaging, the method comprising:
embedding a selectable button within online content;
providing an online messaging mechanism; and
transmitting the online content as a generated message to one or more recipients through the online messaging mechanism upon selection of the selectable button.

14. The computer program product of claim 13, wherein the online messaging mechanism includes an instant messaging mechanism, and the selectable content is displayed on a device, including mobile phone, tablet, laptop or PC.

15. The computer program product of claim 13, wherein the online content in the transmitted messages is shown within a single application, or
wherein the online content from more than one application is represented within a single application.

16. The computer program product of claim 13, further comprising:
allowing with action buttons a user to take predetermined actions, including buying a product or service, or scheduling an appointment directly from the transmitted messages based on the online content.

17. The computer program product of claim 13, wherein the online content is from a web page, and the generated message is related to conversations via a web browser.

18. The computer program product of claim 13, wherein the online content includes locations on a map of a map application, and the generated message is related to in conversations sent directly from the map application.
